(19) United States
(12) Patent Application Publication
(10) Pub. No.: US 2016/0357291 A1
(43) Pub. Date: Dec. 8, 2016

(54) TOUCH DISPLAY DEVICE

(71) Applicant: InnoLux Corporation, Miao-Li County (TW)

(72) Inventors: Hung-Kun CHEN, Miao-Li County (TW); Tsan-Chu LU, Miao-Li County (TW); Chu-Hung TSAI, Miao-Li County (TW); Hsieh-Li CHOU, Miao-Li County (TW); Yu-Chien KAO, Miao-Li County (TW); Li-Wei SUNG, Miao-Li County (TW)

(21) Appl. No.: 15/161,070

(22) Filed: May 20, 2016

Related U.S. Application Data
(60) Provisional application No. 62/171,592, filed on Jun. 5, 2015.

(30) Foreign Application Priority Data
Nov. 30, 2015 (TW) 104139870

(51) Int. Cl. G06F 3/041

(52) U.S. Cl. CPC G06F 3/0412

(57) ABSTRACT

A touch display device is provided. The touch display device includes a first substrate having at least one pixel unit, wherein the pixel unit includes a non-light-shielding region and a light-shielding region and includes a transistor disposed over the first substrate and a first insulating layer disposed over the first substrate and disposed over the transistor. The pixel unit further includes a touch signal line disposed over the first insulating layer and a second insulating layer disposed over the first insulating layer and the touch signal line. The second insulating layer has a recess corresponding to the non-light-shielding region. The pixel unit further includes a first electrode disposed over the second insulating layer and disposed in the recess. The touch display device further includes a second substrate disposed opposite the first substrate and a display medium disposed between the first substrate and the second substrate.

### CROSS REFERENCE TO RELATED APPLICATIONS

This application claims priority of Taiwan Patent Application No. 104139870, filed on Nov. 30, 2015. This application also claims the benefit of U.S. provisional application of, U.S. Patent Application No. 62/171,592 filed on Jun. 5, 2015 and the entirety of which is incorporated by reference herein.

### BACKGROUND

Technical Field

The disclosure relates to a display device, and in particular to an in-cell touch display device.

Description of the Related Art

As technology progresses, several information devices are being developed, such as mobile phones, tablet PCs, ultra-thin laptops, and satellite navigation. Except for using a keyboard or mouse to keying in and control, a popular way to control information devices is through touch technology. The touch display device has a user-friendly and intuitive user interface so that users of all ages may select or control their information devices using a finger or stylus.

One of these touch display devices is an in-cell touch display device, which has a sensing-electrode disposed in the display panel (such as a liquid-crystal display panel). However, the existing in-cell touch display devices have not been satisfactory in every respect.

Therefore, a touch display device which may further improve display quality is needed.

### SUMMARY

The present disclosure provides a touch display device, including: a first substrate including at least one pixel unit, wherein the pixel unit includes a non-light-shielding region and a light-shielding region, and wherein the pixel unit includes: a transistor disposed over the first substrate; a first insulating layer disposed over the first substrate and the transistor; a touch signal line disposed over the first insulating layer; a second insulating layer disposed over the first insulating layer and the touch signal line, wherein the second insulating layer has a recess corresponding to the non-light-shielding region; and a first electrode disposed over the second insulating layer and disposed in the recess; a second substrate disposed opposite the first substrate; and a display medium disposed between the first substrate and the second substrate.

The present disclosure also provides a touch display device, including: a first substrate including at least one pixel unit, wherein the pixel unit includes a non-light-shielding region and a light-shielding region, and wherein the pixel unit includes: a transistor disposed over the first substrate; a first insulating layer disposed over the first substrate and the transistor; a first electrode disposed over the first insulating layer; a second insulating layer disposed over the first insulating layer and the first electrode, a touch signal line disposed over the second insulating layer; a third insulating layer disposed over the second insulating layer and covering the touch signal line, wherein the third insulating layer has a first recess corresponding to the non-light-shielding region; and a second electrode disposed over the third insulating layer and disposed in the first recess; a second substrate disposed opposite the first substrate; and a display medium disposed between the first substrate and the second substrate.

A detailed description is given in the following embodiments with reference to the accompanying drawings.

### BRIEF DESCRIPTION OF THE DRAWINGS

The disclosure may be more fully understood by reading the subsequent detailed description and examples with references made to the accompanying drawings, wherein:

FIG. 1A is a top view of a touch display device in accordance with some embodiments of the present disclosure;

FIG. 1B is a partially enlarged figure of region 1B of the touch display device in FIG. 1A;

FIG. 2A is a cross-sectional view along line 2A-2A′ in FIGS. 1A-1B in accordance with some embodiments of the present disclosure;

FIG. 2B is a cross-sectional view along line 2B-2B′ in FIGS. 1A-1B in accordance with some embodiments of the present disclosure;

FIG. 2C is a cross-sectional view along line 2A-2A′ in FIGS. 1A-1B in accordance with another embodiment of the present disclosure;

FIG. 3A is a cross-sectional view along line 2A-2A′ in FIGS. 1A-1B in accordance with another embodiment of the present disclosure;

FIG. 3B is a cross-sectional view along line 2B-2B′ in FIGS. 1A-1B in accordance with another embodiment of the present disclosure; and

FIG. 3C is a cross-sectional view along line 2B-2B′ in FIGS. 1A-1B in accordance with another embodiment of the present disclosure.

### DETAILED DESCRIPTION

The touch display device of the present disclosure is described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. In addition, in this specification, expressions such as “first material layer disposed on/over a second material layer”, may indicate the direct contact of the first material layer and the second material layer, or it may indicate a non-contact state with one or more intermediate layers between the first material layer and the second material layer. In the above situation, the first material layer may not be in direct contact with the second material layer.

It should be noted that the elements or devices in the drawings of the present disclosure may be present in any form or configuration known to those skilled in the art. In addition, the expression “a layer overlying another layer”, “a layer is disposed above another layer”, “a layer is disposed on another layer” and “a layer is disposed over another layer” may indicate that the layer is in direct contact with the other layer, or that the layer is not in direct contact with the other layer, there being one or more intermediate layers disposed between the layer and the other layer.

In addition, in this specification, relative expressions are used. For example, “lower”, “bottom”, “higher” or “top” are used to describe the position of one element relative to another. It should be appreciated that if a device is flipped upside down, an element that is “lower” will become an element that is “higher”.

The terms “about” and “substantially” typically mean +/−20% of the stated value, more typically +/−10% of the stated value, more typically +/−5% of the stated value, more typically +/−3% of the stated value, more typically +/−2% of the stated value, more typically +/−1% of the stated value and even more typically +/−0.5% of the stated value. The stated value of the present disclosure is an approximate value. When there is no specific description, the stated value includes the meaning of “about” or “substantially”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another region, layer or section. Thus, a first element, component, region, layer, portion or section discussed below could be termed a second element, component, region, layer, portion or section without departing from the teachings of the present disclosure.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

This description of the exemplary embodiments is intended to be read in connection with the accompanying drawings, which are to be considered part of the entire written description. The drawings are not drawn to scale. In addition, structures and devices are shown schematically in order to simplify the drawing.

In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

The term “substrate” is meant to include devices formed within a transparent substrate and the layers overlying the transparent substrate. All transistor element needed may be already formed over the substrate. However, the substrate is represented with a flat surface in order to simplify the drawing. The term “substrate surface” is meant to include the uppermost exposed layers on a transparent substrate, such as an insulating layer and/or metallurgy lines.

The embodiment of the present disclosure reduces the distance between the pixel electrode and the common electrode to increase the capacitance between the pixel electrode and the common electrode, which in turn improves the display quality of the display device.

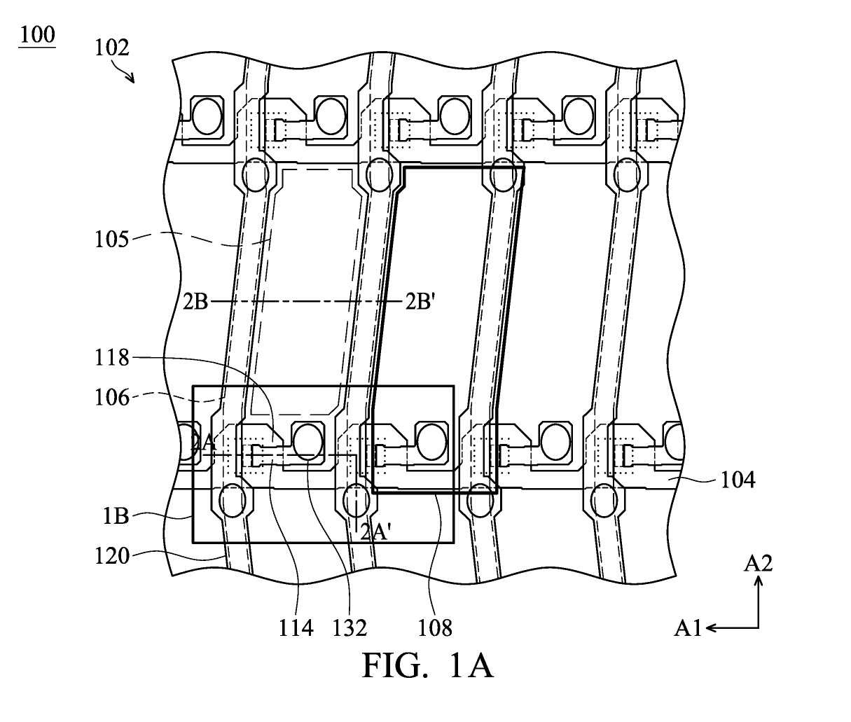

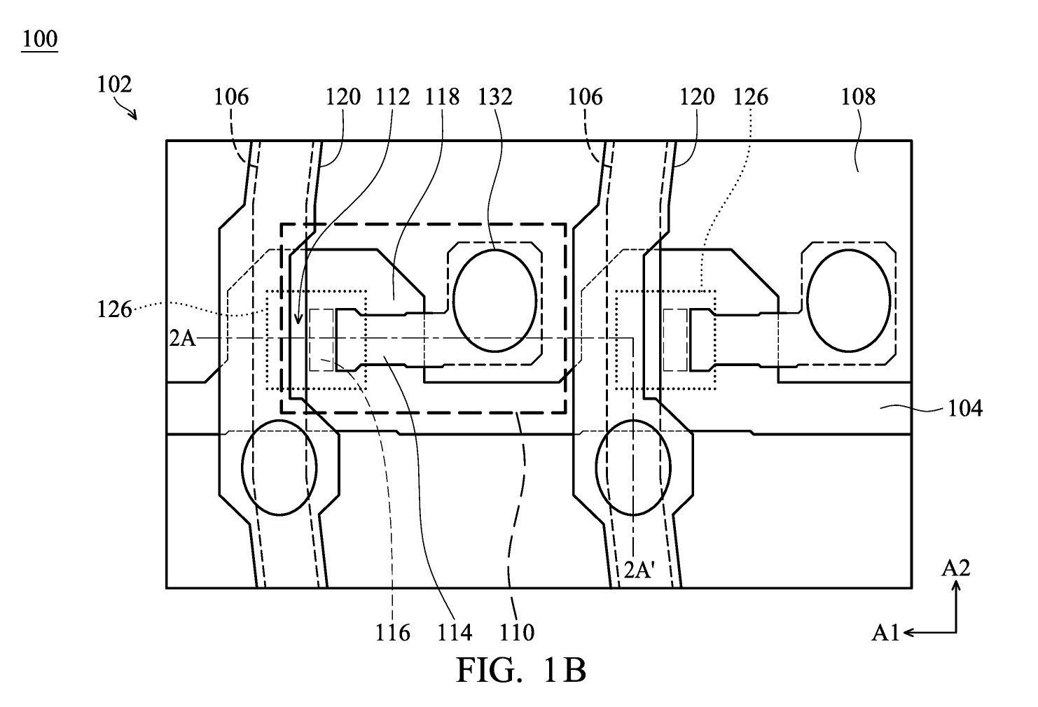

FIGS. 1A-1B are top views of a substrate 102 of a display device 100 in accordance with some embodiments of the present disclosure. As shown in FIGS. 1A-1B, the substrate 102 may include a scan line (gate line) 104, which extends along a first direction A1. The substrate 102 may further include a data line 106, which intersects the scan line 104. In other words, the gate line 104 extends along direction A1, and the direction A2 refers to a direction that is substantially perpendicular or orthogonal to the scan-line (or gate-line) extending direction A1. In addition, the substrate 102 may further include thin film transistors 110 corresponding to each pixel unit 108, such as sub-pixel 108. In addition, the pixel unit 108 further includes an aperture region 105 (corresponding to the subsequent non-light-shielding region).

The data line 106 may provide the signal to the sub-pixels 108 through the thin film transistors 110. The scan line (gate line) 104 may provide the scanning pulse signal to the thin film transistors 110 and control the sub-pixels 108 in coordination with the aforementioned signal.

The thin film transistor 110 includes a drain electrode 112, a source electrode 114, a channel region 116 between the drain electrode 112 and source electrode 114, and a gate electrode 118. The gate electrode 118 extends from the scan line 104 along the second direction A2. The drain electrode 112 is a portion of the data line 106.

In addition, the substrate 102 may further include a touch signal line 120. The touch signal line 120 substantially overlaps with the data line 106.

It should be noted that, in order to clearly describe the embodiments of the present disclosure, the subsequent pixel electrode and common electrode are not shown in FIGS. 1A-1B.

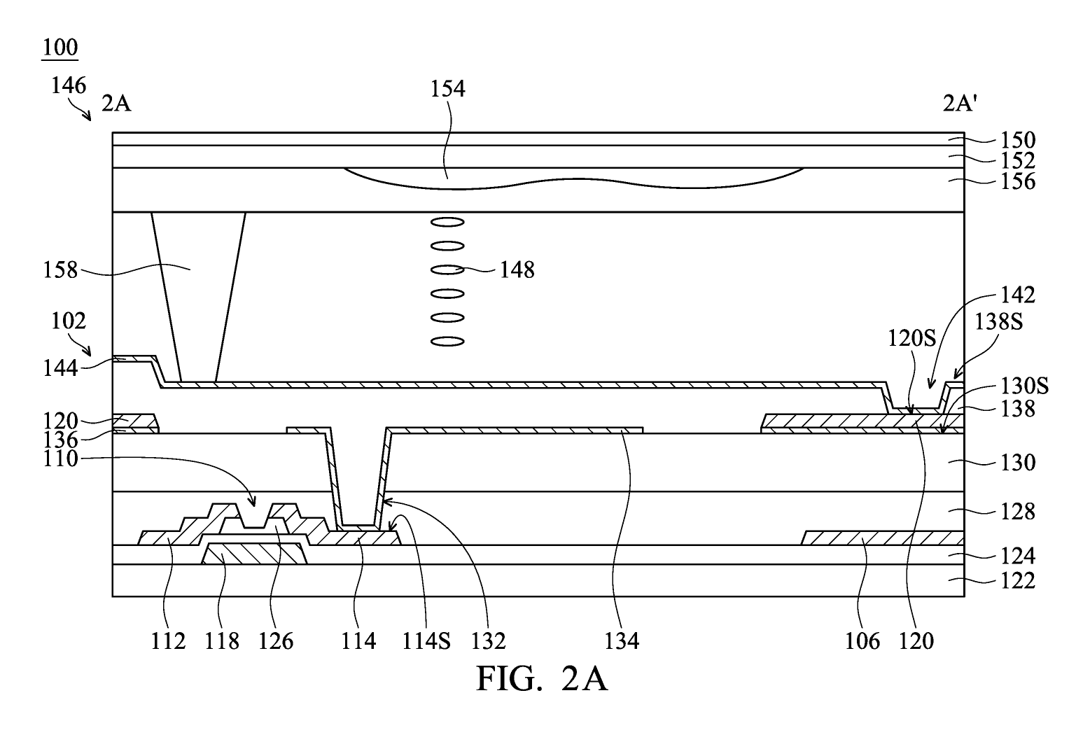

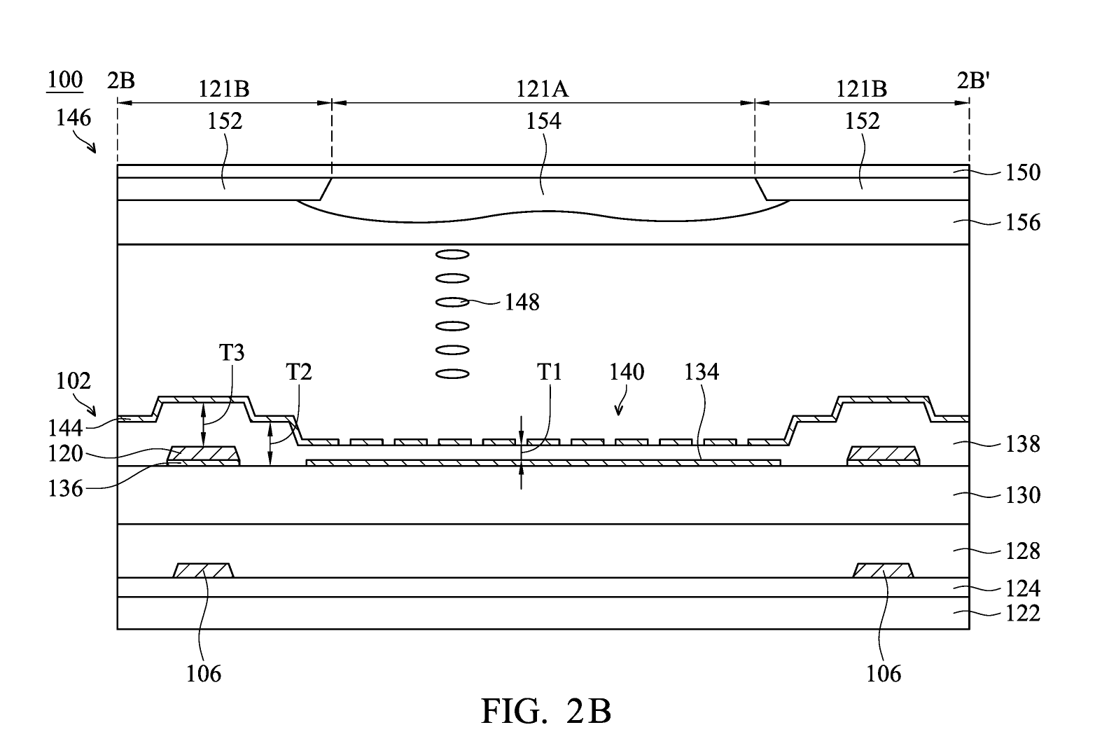

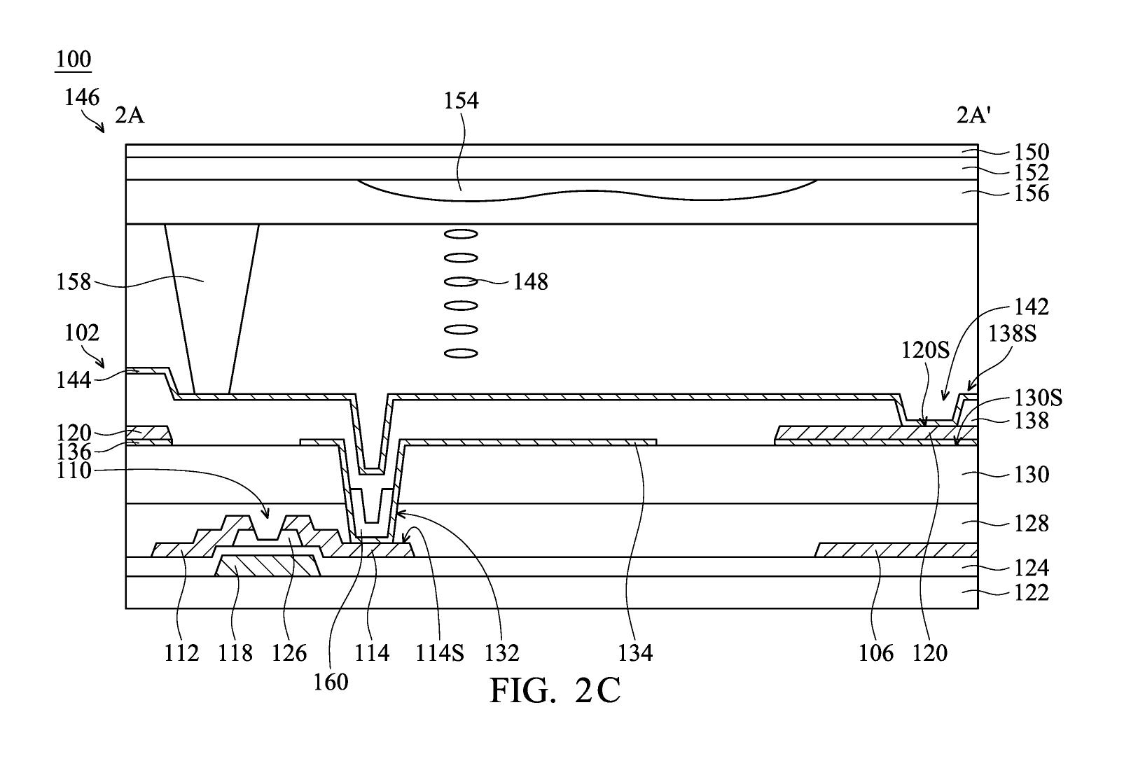

FIG. 2A is a cross-sectional view of the display device 100 along line 2A-2A′ in FIGS. 1A-1B in accordance with some embodiments of the present disclosure. FIG. 2B is a cross-sectional view along line 2B-2B′ in FIGS. 1A-1B in accordance with some embodiments of the present disclosure. As shown in FIG. 2B, the substrate 102 (or the pixel unit 108) includes a non-light-shielding region 121A (corresponding to the aperture region 105 in FIG. 1A) and a light-shielding region 121B. The non-light-shielding region 121A refers to the region not shielded by the light-shielding layer or metal. In addition, as shown in FIG. 2A, the substrate 102 may include a first substrate 122. The first substrate 122 may include, but is not limited to, a transparent substrate, such as a glass substrate, a ceramic substrate, a plastic substrate, or any other suitable transparent substrate. The thin film transistor 110 includes a gate electrode 118 disposed over the first substrate 122 and a gate dielectric layer 124 disposed over the gate electrode 118 and the first substrate 122.

The material of the gate electrode 118 may include, but is not limited to, amorphous silicon, poly-silicon, one or more metal, metal nitride, conductive metal oxide, or a combination thereof. The metal may include, but is not limited to, molybdenum, tungsten, titanium, tantalum, platinum, or hafnium. The metal nitride may include, but is not limited to, molybdenum nitride, tungsten nitride, titanium nitride or tantalum nitride. The conductive metal oxide may include, but is not limited to, ruthenium oxide or indium tin oxide. The conductive material layer may be formed by the previously described chemical vapor deposition (CVD), sputtering, resistive thermal evaporation, electron beam evaporation, or any other suitable methods. For example, in one embodiment, the amorphous silicon conductive material layer or poly-silicon conductive material layer may be deposited and formed by low-pressure chemical vapor deposition at about 525° C.˜650° C. The thickness of the amorphous silicon conductive material layer or poly-silicon conductive material layer may range from about 1000 Å to 10000 Å.

The material of the gate dielectric layer 124 may include, but is not limited to, silicon oxide, silicon nitride, silicon oxynitride, high-k material, any other suitable dielectric material, or a combination thereof. The high-k material may include, but is not limited to, metal oxide, metal nitride, metal silicide, transition metal oxide, transition metal nitride, transition metal silicide, transition metal oxynitride, metal aluminate, zirconium silicate, zirconium aluminate. For example, the material of the high-k material may include, but is not limited to, LaO, AlO, ZrO, TiO, Ta₂O₅, Y₂O₃, SrTiO₃(STO), BaTiO₃(BTO), BaZrO, HfO₂, HfO₃, HfZrO, HfLaO, HfSiO, HfSiON, LaSiO, AlSiO, HfTaO, HfTiO, HfTaTiO, HfAlON, (Ba,Sr)TiO₃(BST), Al₂O₃, any other suitable high-k dielectric material, or a combination thereof. The gate dielectric layer may be formed by chemical vapor deposition or spin-on coating. The chemical vapor deposition may include, but is not limited to, low pressure chemical vapor deposition (LPCVD), low temperature chemical vapor deposition (LTCVD), rapid thermal chemical vapor deposition (RTCVD), plasma enhanced chemical vapor deposition (PECVD), atomic layer deposition (ALD), or any other suitable method.

The thin film transistors 110 further includes a semiconductor layer 126 disposed over the gate dielectric layer 124. The semiconductor layer 126 overlaps with the gate electrode 118. The drain electrode 112 and the source electrode 114 are disposed at two opposite sides of the semiconductor layer 126, respectively. The drain electrode 112 and the source electrode 114 contact with the portions of the semiconductor layer 126 at the opposite sides, respectively.

The semiconductor layer 126 may include an element semiconductor which may include silicon, germanium; a compound semiconductor which may include gallium nitride (GaN), silicon carbide, gallium arsenide, gallium phosphide, indium phosphide, indium arsenide and/or indium antimonide; an alloy semiconductor which may include SiGe alloy, GaAsP alloy, AlInAs alloy, AlGaAs alloy, GaInAs alloy, GaInP alloy and/or GaInAsP alloy; or a combination thereof.

The drain electrode 112 and the source electrode 114 may include, but is not limited to, copper, aluminum, molybdenum, tungsten, gold, cobalt, nickel, platinum, titanium, iridium, rhodium, an alloy thereof, a combination thereof, or any other conductive material. For example, the drain electrode 112 and the source electrode 114 may include multi-layer structure such as Mo/Al/Mo or Ti/Al/Ti. In other embodiments, the drain electrode 112 and source electrode 114 may include any conductive material made of a nonmetal material. The material of the drain electrode 112 and the source electrode 114 may be formed by chemical vapor deposition (CVD), sputtering, resistive thermal evaporation, electron beam evaporation, or any other suitable method. In some embodiments, the materials of the drain electrode 112 and the source electrode 114 may be the same, and the drain electrode 112 and the source electrode 114 may be formed by the same deposition steps. However, in other embodiments, the drain electrode 112 and the source electrode 114 may be formed by different deposition steps, and the materials of the drain electrode 112 and the source electrode 114 may be different from each other.

Still referring to FIG. 2A, the substrate 102 further includes a first insulating layer 128 disposed over the thin film transistor 110 and gate dielectric layer 124. The material of the first insulating layer 128 may include, but is not limited to, silicon nitride, silicon oxide, or silicon oxynitride. The first insulating layer 128 may be formed by chemical vapor deposition or spin-on coating. The chemical vapor deposition may include, but is not limited to, low pressure chemical vapor deposition (LPCVD), low temperature chemical vapor deposition (LTCVD), rapid thermal chemical vapor deposition (RTCVD), plasma enhanced chemical vapor deposition (PECVD), atomic layer deposition (ALD), or any other suitable method.

Subsequently, a second insulating layer 130 may be optionally disposed over the first insulating layer 128. The material of the second insulating layer 130 may include, but is not limited to, organic insulating materials (such as photosensitive resins) or inorganic insulating materials (such as silicon nitride, silicon oxide, silicon oxynitride, silicon carbide, aluminum oxide, or a combination thereof). In addition, the second insulating layer 130 and first insulating layer 128 may be etched by two etching steps respectively to form an opening 132. The opening 132 extends downward from the top surface 130S of the second insulating layer 130 to the source electrode 114, and exposes a portion of the surface 114S of the source electrode 114. In other words, the opening 132 exposes the thin film transistor 110.

Next, the touch signal line 120 is disposed over the second insulating layer 130. The touch signal line 120 may include, but is not limited to, copper, aluminum, molybdenum, tungsten, gold, cobalt, nickel, platinum, titanium, iridium, rhodium, an alloy thereof, a combination thereof, or any other conductive material. For example, the touch signal line 120 may include three-layered structure such as Mo/Al/Mo or Ti/Al/Ti. In other embodiments, the touch signal line 120 includes a nonmetal material. The touch signal line 120 may include any conductive material. The material of the touch signal line 120 may be formed by chemical vapor deposition (CVD), sputtering, resistive thermal evaporation, electron beam evaporation, or any other suitable method.

Still referring to FIGS. 2A-2B, the display device 100 further includes a pixel electrode 134. The pixel electrode 134 extends into the opening 132 and is electrically connected to the thin film transistor 110. In particular, the pixel electrode 134 is disposed over the second insulating layer 130 (or over the first insulating layer 128), over the sidewall of the opening 132 and over the surface 114S of the source electrode 114. The pixel electrode 134 is electrically connected to the source electrode 114. In addition, the display device 100 further includes a lining layer 136 disposed between the touch signal line 120 and the second insulating layer 130 (or the first insulating layer 128). The materials of the lining layer 136 and pixel electrode 134 may be the same, and the lining layer 136 and pixel electrode 134 may be formed by the same deposition, photolithography and etching steps. The material of the lining layer 136 and pixel electrode 134 may include, but is not limited to, transparent conductive material such as indium tin oxide (ITO), tin oxide (SnO), indium zinc oxide (IZO), indium gallium zinc oxide (IGZO), indium tin zinc oxide (ITZO), antimony tin oxide (ATO), antimony zinc oxide (AZO), a combination thereof, or any other suitable transparent conductive oxide.

Still referring to FIG. 2A, the display device 100 further includes a third insulating layer 138 disposed over the second insulating layer 130 (or the first insulating layer 128) and covering the touch signal line 120 and pixel electrode 134. The second insulating layer 130 is disposed between the first insulating layer 128 and third insulating layer 138. The third insulating layer 138 has an opening 142. The opening 142 extends downward from the top surface 138S of the third insulating layer 138 to the top surface 120S of the touch signal line 120.

In addition, as shown in FIG. 2B, the third insulating layer 138 has a recess 140 at the aperture region 105, the recess 140 substantially corresponds to the non-light-shielding region 121A. In some embodiments, the recess 140 may be formed by gray-level mask. In particular, the gray-level mask may include gray-tone mask or half-tone mask. The gray-tone mask has slits with width less than the resolution of the exposure machine. The gray-tone mask shield a portion of light by the portion having these slits to achieve the effect of half exposure. The half-tone mask uses a translucent film to achieve the effect of half exposure. The two aforementioned methods may achieve three exposure levels (i.e. exposed portion, half-exposed portion and non-exposed portion) through one exposure step; therefore, a photoresist (photo-sensitizer) with two thicknesses may be formed after the exposure step. The recess 140 may be formed in the third insulating layer 138 by (?) using the thickness difference of the photoresist and the subsequent etch steps.

In addition, in other embodiments, the third insulating layer 138 may include a plurality of insulating layers with different etch selectivity, and the recess 140 may be formed by performing two or more photolithography and etching steps.

The display device 100 further include a common electrode 144 disposed over the third insulating layer 138 and electrically connected to the touch signal line 120. In particular, the common electrode 144 is disposed over the third insulating layer 138, and extends over the sidewall of the opening 142 and over the top surface 120S of the touch signal line 120. The common electrode 144 is electrically connected to the touch signal line 120. In addition, the common electrode 144 not only serves as the common electrode when the display device 100 is touched, but also serves as the sensing electrode of the display device.

In addition, the common electrode 144 is disposed in the recess 140. As shown in FIG. 2B, since the common electrode 144 is disposed in the recess 140 in some embodiments of the present disclosure, the distance between the pixel electrode 134 and the common electrode 144 may be reduced to increase the capacitance between the pixel electrode 134 and the common electrode 144, which in turn improves the display quality of the display device.

In addition, still referring to FIG. 2B, the third insulating layer 138 in the non-light-shielding region 121A (corresponding to the aperture region 105 in FIG. 1A) has a thickness T1 between the pixel electrode 134 and the common electrode 144, and the third insulating layer 138 in the light-shielding region 121B has a thickness T2. The thickness T1 is less than the thickness T2.

As shown in FIG. 2B, since the thickness T1 is less than the thickness T2 in some embodiments of the present disclosure, the distance between the pixel electrode 134 and the common electrode 144 may be reduced to increase the capacitance between the pixel electrode 134 and the common electrode 144, which in turn improves the display quality of the display device.

In addition, in some embodiments, at the portion where the common electrode 144 is not in direct contact with the touch signal line 120, the third insulating layer 138 has a thickness T3 between the common electrode 144 and the touch signal line 120. The thickness T2 is substantially equal to the thickness T3.

Since the thickness T2 may be equal to the thickness T3 in some embodiments of the present disclosure, the touch signal line 120 and the common electrode 144 may be spaced apart by a constant distance. Therefore, the coupling effect between the touch signal line 120 and the common electrode 144 may be reduced, which in turn may further improve the display quality of the display device.

In some embodiments, the thickness T1 may be about 1000±500 Å. The thickness T2 may be about 2000 Å-3000 Å. The thickness T3 may be about 2000 Å-3000 Å.

In addition, still referring to FIGS. 2A-2B, display device 100 further includes a second substrate 146 disposed opposite the substrate 102 and a display medium 148 disposed between the substrate 102 and the second substrate 146.

The display device 100 may include, but is not limited to, a touch liquid-crystal display such as a thin film transistor liquid-crystal display. The liquid-crystal display may include, but is not limited to, a twisted nematic (TN) liquid-crystal display, a super twisted nematic (STN) liquid-crystal display, a double layer super twisted nematic (DSTN) liquid-crystal display, a vertical alignment (VA) liquid-crystal display, an in-plane switching (IPS) liquid-crystal display, a cholesteric liquid-crystal display, a blue phase liquid-crystal display, fringe field switching liquid-crystal display, or any other suitable liquid-crystal display.

In some embodiments, the second substrate 146 serves as a color filter substrate. In particular, the second substrate 146, which serves as a color filter substrate, may include a substrate 150, a light-shielding layer 152 disposed over the substrate 150, a color filter layer 154 disposed over the light-shielding layer 152 and the substrate 150, and a protection layer 156 (or over-coating layer) covering the light-shielding layer 152 and the color filter layer 154.

In addition, in some embodiments, the region of the substrate 102 corresponding to the light-shielding layer 152 of the second substrate 146 is the light-shielding region 121B.

The substrate 150 may include a transparent substrate such as a glass substrate, a ceramic substrate, a plastic substrate, or any other suitable transparent substrate. The light-shielding layer 152 may include, but is not limited to, black photoresist, black printing ink, black resin. The color filter layer 154 may include a red color filter layer, a green color filter layer, a blue color filter layer, or any other suitable color filter layer.

The display device 100 further includes a spacer 158 disposed between the substrate 102 and second substrate 146. The spacer 158 is the main structure used to space the substrate 102 apart from the second substrate 146 to prevent the substrate 102 from touching the second substrate 146 when the display device 100 is pressed or touched.

FIG. 2C is a cross-sectional view of the display device 200 in accordance with another embodiment of the present disclosure. Note that the same or similar elements or layers corresponding to those of the semiconductor device are denoted by like reference numerals. The same or similar elements or layers denoted by like reference numerals have the same meaning and will not be repeated for the sake of brevity.

The difference between the embodiments shown in FIGS. 2C and 2A-2B is that the substrate 102 further include a lining layer 160 disposed over the pixel electrode 134 in the opening 132. In addition, the third insulating layer 138 is filled into the opening 132, and the lining layer 160 is disposed between the pixel electrode 134 and the third insulating layer 138.

The lining layer 160 may include, but is not limited to, copper, aluminum, molybdenum, tungsten, gold, cobalt, nickel, platinum, titanium, iridium, rhodium, an alloy thereof, a combination thereof, or any other conductive material. For example, the lining layer 160 may include three-layered structure such as Mo/Al/Mo or Ti/Al/Ti. In other embodiments, the lining layer 160 includes a non-metal material. The lining layer 160 may include any conductive material. The material of the lining layer 160 may be formed by chemical vapor deposition (CVD), sputtering, resistive thermal evaporation, electron beam evaporation, or any other suitable method. In some embodiments, the materials of the touch signal line 120 and lining layer 160 may be the same, and the touch signal line 120 and the lining layer 160 may be formed by the same deposition steps. However, in other embodiments, the touch signal line 120 and the lining layer 160 may be formed by different deposition steps, and the materials of the touch signal line 120 and lining layer 160 may be different from each other.

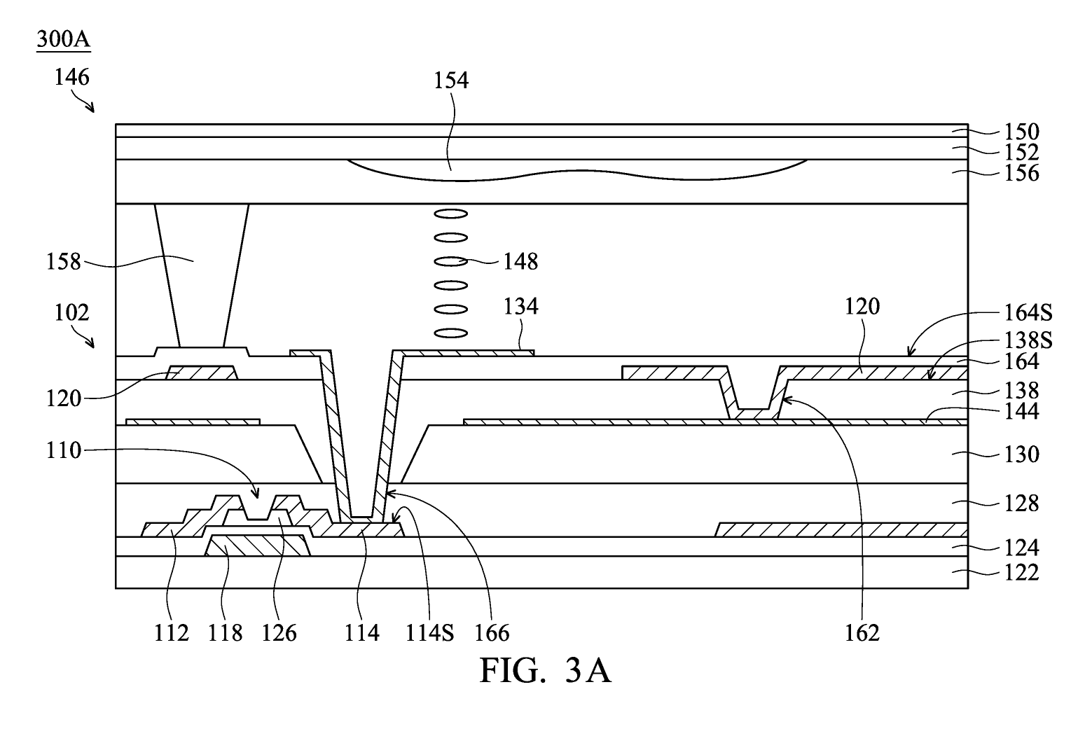

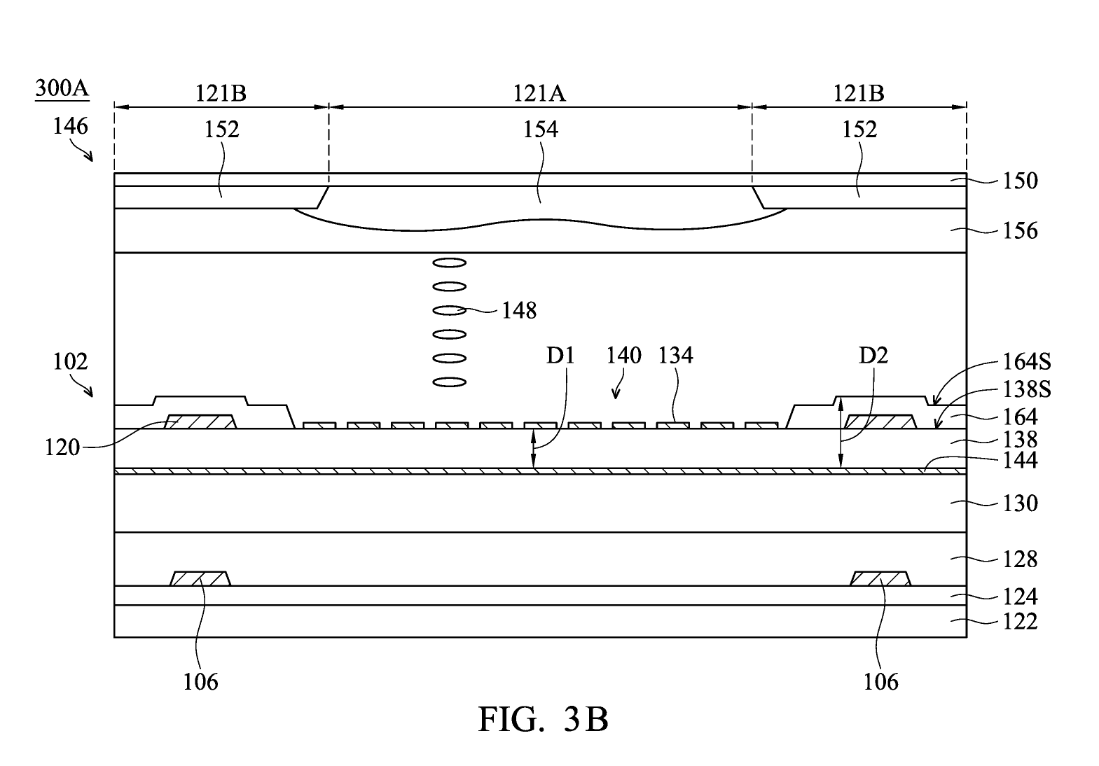

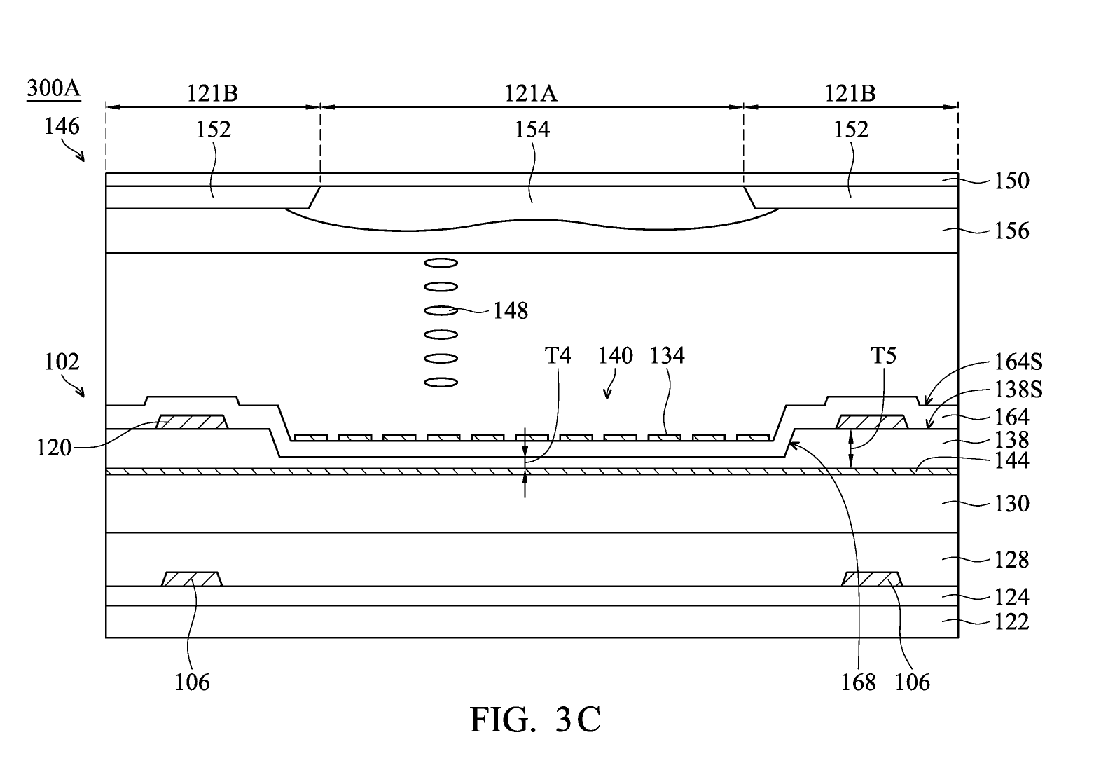

It should be noted that the exemplary embodiments set forth in FIGS. 1A-2C are merely for the purpose of illustration. In addition to the embodiments set forth in FIGS. 1A-2C, the common electrode, pixel electrode and touch signal line of the present disclosure may have other configurations as shown in FIG. 3. This will be described in detail in the following description. Therefore, the inventive concept and scope are not limited to the exemplary embodiments shown in FIGS. 1A-2C.

FIG. 3A is a cross-sectional view of display device 300A along line 2A-2A′ in FIGS. 1A-1B in accordance with another embodiment of the present disclosure. FIG. 3B is a cross-sectional view of display device 300A along line 2B-2B′ in FIGS. 1A-1B in accordance with another embodiment of the present disclosure. Note that the same or similar elements or layers corresponding to those of the semiconductor device are denoted by like reference numerals. The same or similar elements or layers denoted by like reference numerals have the same meaning and will not be repeated for the sake of brevity.

As shown in FIG. 3B, the substrate 102 includes a non-light-shielding region 121A and a light-shielding region 121B. The substrate 102 may include a first substrate 122. The first substrate 122 may include, but is not limited to, a transparent substrate, such as a glass substrate, a ceramic substrate, a plastic substrate, or any other suitable transparent substrate. As shown in FIG. 3A, the thin film transistor 110 includes a gate electrode 118 disposed over the first substrate 122 and a gate dielectric layer 124 disposed over the gate electrode 118 and the first substrate 122.

The thin film transistors 110 further includes a semiconductor layer 126 disposed over the gate dielectric layer 124. The semiconductor layer 126 overlaps with the gate electrode 118. The drain electrode 112 and the source electrode 114 are disposed at opposite sides of the semiconductor layer 126, respectively. The drain electrode 112 and the source electrode 114 overlap with two portions of the semiconductor layer 126 at the opposite sides, respectively.

The drain electrode 112 and the source electrode 114 may include, but is not limited to, copper, aluminum, molybdenum, tungsten, gold, cobalt, nickel, platinum, titanium, iridium, rhodium, an alloy thereof, a combination thereof, or any other conductive material. For example, the drain electrode 112 and the source electrode 114 may include three-layered structure such as Mo/Al/Mo or Ti/Al/Ti. In other embodiments, the drain electrode 112 and source electrode 114 includes a non-metal material. The drain electrode 112 and the source electrode 114 may include any conductive material. The material of the drain electrode 112 and the source electrode 114 may be formed by chemical vapor deposition (CVD), sputtering, resistive thermal evaporation, electron beam evaporation, or any other suitable method. In some embodiments, the materials of the drain electrode 112 and the source electrode 114 may be the same, and the drain electrode 112 and the source electrode 114 may be formed by the same deposition steps. However, in other embodiments, the drain electrode 112 and the source electrode 114 may be formed by different deposition steps, and the materials of the drain electrode 112 and the source electrode 114 may be different from each other.

Still referring to FIG. 3A, the substrate 102 further includes a first insulating layer 128 disposed over the thin film transistor 110 and gate dielectric layer 124. The material of the first insulating layer 128 may include, but is not limited to, silicon nitride, silicon oxide, or silicon oxynitride. The first insulating layer 128 may be formed by chemical vapor deposition or spin-on coating. The chemical vapor deposition may include, but is not limited to, low pressure chemical vapor deposition (LPCVD), low temperature chemical vapor deposition (LTCVD), rapid thermal chemical vapor deposition (RTCVD), plasma enhanced chemical vapor deposition (PECVD), atomic layer deposition (ALD), or any other suitable method.

Subsequently, a second insulating layer 130 may be optionally disposed over the first insulating layer 128. The material of the second insulating layer 130 may include, but is not limited to, organic insulating materials (such as photosensitive resins) or inorganic insulating materials (such as silicon nitride, silicon oxide, silicon oxynitride, silicon carbide, aluminum oxide, or a combination thereof).

Still referring to FIGS. 3A-3B, the substrate 102 further includes a common electrode 144 disposed over the second insulating layer 130 (or over the first insulating layer 128). The material of the common electrode 144 may include, but is not limited to, transparent conductive material such as indium tin oxide (ITO), tin oxide (SnO), indium zinc oxide (IZO), indium gallium zinc oxide (IGZO), indium tin zinc oxide (ITZO), antimony tin oxide (ATO), antimony zinc oxide (AZO), a combination thereof, or any other suitable transparent conductive oxide. In addition, the common electrode 144 not only serves as the common electrode when the display device 100 is touched, but also provides the touch sensing signal of the display device. In some embodiments, the driving method for touch-control may include the self-capacitive type.

Still referring to FIGS. 3A-3B, the display device 300A further includes a third insulating layer 138 disposed over the second insulating layer 130 (or the first insulating layer 128) and covering the common electrode 144. The material of the third insulating layer 138 may include, but is not limited to, silicon nitride, silicon oxide, or silicon oxynitride. The second insulating layer 130 is disposed between the first insulating layer 128 and third insulating layer 138. The third insulating layer 138 has an opening 162. The opening 162 extends downward from the top surface 138S of the third insulating layer 138 to the common electrode 144.

Next, the touch signal line 120 is disposed over the third insulating layer 138. The touch signal line 120 is electrically connected to the common electrode 144 through the opening 162.

The touch signal line 120 may include, but is not limited to, copper, aluminum, molybdenum, tungsten, gold, cobalt, nickel, platinum, titanium, iridium, rhodium, an alloy thereof, a combination thereof, or any other conductive material. For example, the touch signal line 120 may include a three-layered structure such as Mo/Al/Mo or Ti/Al/Ti. In other embodiments, the touch signal line 120 includes a nonmetal material. The touch signal line 120 may include any conductive material. The material of the touch signal line 120 may be formed by chemical vapor deposition (CVD), sputtering, resistive thermal evaporation, electron beam evaporation, or any other suitable method.

Still referring to FIGS. 3A-3B, the display device 300A further includes a fourth insulating layer 164 disposed over the third insulating layer 138 and covering the touch signal line 120. The material of the fourth insulating layer 164 may include, but is not limited to, silicon nitride, silicon oxide, or silicon oxynitride. In addition, as shown in FIG. 3A, the substrate 102 may further include an opening 166. The opening 166 extends through the fourth insulating layer 164, third insulating layer 138, second insulating layer 130 and first insulating layer 128 and exposes the thin film transistor 110. In other words, the opening 166 exposes a portion of the surface 114S of the source electrode 114.

Still referring to FIGS. 3A-3B, the display device 300A further includes a pixel electrode 134. The pixel electrode 134 is disposed over the fourth insulating layer 164 and is electrically connected to the thin film transistor 110. The material of the pixel electrode 134 may include, but is not limited to, transparent conductive material such as indium tin oxide (ITO), tin oxide (SnO), indium zinc oxide (IZO), indium gallium zinc oxide (IGZO), indium tin zinc oxide (ITZO), antimony tin oxide (ATO), antimony zinc oxide (AZO), a combination thereof, or any other suitable transparent conductive oxide.

As shown in FIG. 3A, the pixel electrode 134 is electrically connected to the transistor 110 through the opening 166. In particular, the pixel electrode 134 is disposed over the fourth insulating layer 164 and extends over the sidewall of the opening 166 and over the surface 114S of the source electrode 114 to electrically connect the source electrode 114.

In addition, as shown in FIG. 3B, the fourth insulating layer 164 has a recess 140, the recess 140 substantially corresponds to the non-light-shielding region 121A (corresponding to the aperture region 105). The pixel electrode 134 is disposed in the recess 140. As shown in FIG. 3A, since the pixel electrode 134 is disposed in the recess 140 in some embodiments of the present disclosure, the distance between the pixel electrode 134 and the common electrode 144 may be reduced to increase the capacitance between the pixel electrode 134 and the common electrode 144, which in turn improves the display quality of the display device.

In addition, referring to FIG. 3B, a distance between the common electrode 144 and the pixel electrode 134 in the recess 140 is a first distance D1. A distance between a top surface 164S of the fourth insulating layer 164 and the common electrode 144 in the light-shielding region 121B is a second distance D2. The first distance D1 is less than the second distance D2.

As shown in FIG. 3B, since the first distance D1 is less than the second distance D2 in some embodiments of the present disclosure, the distance between the pixel electrode 134 and the common electrode 144 may be reduced to increase the capacitance between the pixel electrode 134 and the common electrode 144, which in turn improves the display quality of the display device.

In addition, in some embodiments, as shown in FIG. 3B, the recess 140 penetrates through the fourth insulating layer 164. The pixel electrode 134 in the recess 140 is in contact with the top surface 138S of the third insulating layer 138.

In addition, still referring to FIG. 3A, display device 300A further includes a second substrate 146 disposed opposite the substrate 102 and a display medium 148 disposed between the substrate 102 and the second substrate 146.

The display device 300A may include, but is not limited to, a touch liquid-crystal display such as a thin film transistor liquid-crystal display. The liquid-crystal display may include, but is not limited to, a twisted nematic (TN) liquid-crystal display, a super twisted nematic (STN) liquid-crystal display, a double layer super twisted nematic (DSTN) liquid-crystal display, a vertical alignment (VA) liquid-crystal display, an in-plane switching (IPS) liquid-crystal display, a cholesteric liquid-crystal display, a blue phase liquid-crystal display, fringe field switching liquid-crystal display, or any other suitable liquid-crystal display.

In some embodiments, the second substrate 146 serves as a color filter substrate. In particular, the second substrate 146, which serves as a color filter substrate, may include a substrate 150, a light-shielding layer 152 disposed over the substrate 150, a color filter layer 154 disposed over the light-shielding layer 152 and the substrate 150, and a protection layer 156 covering the light-shielding layer 152 and the color filter layer 154.

In addition, in some embodiments, the region of the substrate 102 corresponding to the light-shielding layer 152 of the second substrate 146 is the light-shielding region 121B.

The substrate 150 may include a transparent substrate such as a glass substrate, a ceramic substrate, a plastic substrate, or any other suitable transparent substrate. The light-shielding layer 152 may include, but is not limited to, black photoresist, black printing ink, black resin. The color filter layer 154 may include a red color filter layer, a green color filter layer, a blue color filter layer, or any other suitable color filter layer.

The display device 300A further includes a spacer 158 disposed between the substrate 102 and second substrate 146. The spacer 158 is the main structure used to space the substrate 102 apart from the second substrate 146 to prevent the substrate 102 from touching the second substrate 146 when the display device 300A is pressed or touched.

FIG. 3C is a cross-sectional view of the display device 300B along line 2B-2B′ in FIGS. 1A-1B in accordance with another embodiment of the present disclosure. Note that the same or similar elements or layers corresponding to those of the semiconductor device are denoted by like reference numerals. The same or similar elements or layers denoted by like reference numerals have the same meaning and will not be repeated for the sake of brevity.

The difference between the embodiments shown in FIGS. 3C and 3B is that the third insulating layer 138 has a recess 168 substantially corresponding to the non-light-shielding region 121A. In addition, the fourth insulating layer 164 is conformally disposed in the recess 168 of the third insulating layer 138 to form the recess 140.

In addition, as shown in FIG. 3C, the third insulating layer 138 in the non-light-shielding region 121A (corresponding to the aperture region 105 in FIG. 1A) has a thickness T4, and the third insulating layer 138 in the light-shielding region 121B has a thickness T5. The thickness T4 is less than the thickness T5. In some embodiments, the thickness T4 may be about 1000±500 Å. The thickness T5 may be about 2000 Å-3000 Å.

As shown in FIG. 3C, since the thickness T4 is less than the thickness T5 in some embodiments of the present disclosure, the distance between the pixel electrode 134 and the common electrode 144 may be reduced to increase the capacitance between the pixel electrode 134 and the common electrode 144, which in turn improves the display quality of the display device.

In summary, in some embodiments of the present disclosure, the distance between the pixel electrode and the common electrode may be reduced to increase the capacitance between the pixel electrode and the common electrode, which in turn improves the display quality of the display device. In addition, in some embodiments of the present disclosure, the touch signal line and the common electrode may be spaced apart by a constant distance. Therefore, the coupling effect between the touch signal line and the common electrode may be reduced, which in turn may further improve the display quality of the display device.

In addition, it should be noted that the drain and source mentioned above in the present disclosure are switchable since the definition of the drain and source is related to the voltage connecting thereto.

Note that the above element sizes, element parameters, and element shapes are not limitations of the present disclosure. Those skilled in the art can adjust these settings or values according to different requirements. It is understood that the touch display device and method for manufacturing the same of the present disclosure are not limited to the configurations of FIGS. 1A to 3C. The present disclosure may merely include any one or more features of any one or more embodiments of FIGS. 1A to 3C. In other words, not all of the features shown in the figures should be implemented in the touch display device and method for manufacturing the same of the present disclosure.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A touch display device, comprising:
a first substrate comprising at least one pixel unit, wherein the pixel unit comprises a non-light-shielding region and a light-shielding region, and wherein the pixel unit comprises:
a transistor disposed over the first substrate;
a first insulating layer disposed over the first substrate and the transistor;
a touch signal line disposed over the first insulating layer;
a second insulating layer disposed over the first insulating layer and the touch signal line, wherein the second insulating layer has a recess corresponding to the non-light-shielding region; and
a first electrode disposed over the second insulating layer and disposed in the recess;
a second substrate disposed opposite the first substrate; and
a display medium disposed between the first substrate and the second substrate.

2. The touch display device as claimed in claim 1, wherein the pixel unit further comprises:
a second electrode disposed between the first insulating layer and the second insulating layer, wherein the first insulating layer has an opening exposing the transistor, and the second electrode is electrically connected to the transistor through the opening,
wherein the second insulating layer in the non-light-shielding region has a first thickness,
wherein the second insulating layer in the light-shielding region has a second thickness, and the first thickness is less than the second thickness.

3. The touch display device as claimed in claim 2, wherein the second insulating layer has a third thickness between the first electrode and the touch signal line, and the second thickness is greater than or equal to the third thickness.

4. The touch display device as claimed in claim 3, wherein the pixel unit further comprises:
a first lining layer disposed between the touch signal line and the first insulating layer.

5. The touch display device as claimed in claim 4, wherein the pixel unit further comprises:
a second lining layer disposed over the second electrode in the opening, wherein the second lining layer is disposed between the second electrode and the second insulating layer.

6. A touch display device, comprising:
a first substrate comprising at least one pixel unit, wherein the pixel unit comprises a non-light-shielding region and a light-shielding region, and wherein the pixel unit comprises:
a transistor disposed over the first substrate;
a first insulating layer disposed over the first substrate and the transistor;
a first electrode disposed over the first insulating layer;
a second insulating layer disposed over the first insulating layer and the first electrode,
a touch signal line disposed over the second insulating layer;
a third insulating layer disposed over the second insulating layer and covering the touch signal line, wherein the third insulating layer has a first recess corresponding to the non-light-shielding region; and
a second electrode disposed over the third insulating layer and disposed in the first recess;
a second substrate disposed opposite the first substrate; and
a display medium disposed between the first substrate and the second substrate.

7. The touch display device as claimed in claim 6,
wherein a first distance between the first electrode and the second electrode in the first recess is less than a second distance between a top surface of the third insulating layer and the first electrode in the light-shielding region.

8. The touch display device as claimed in claim 7, wherein the first recess penetrates through the third insulating layer, wherein the second electrode in the first recess is in contact with a top surface of the second insulating layer.

9. The touch display device as claimed in claim 6,
wherein the second insulating layer in the non-light-shielding region has a first thickness between the first electrode and the second electrode,
wherein the second insulating layer in the light-shielding region has a second thickness, and the first thickness is less than the second thickness.

10. The touch display device as claimed in claim 6, wherein the second insulating layer has a second recess corresponding to the non-light-shielding region, wherein the second recess corresponds to the first recess.

11. The touch display device as claimed in claim 6, wherein the second insulating layer has a first opening, and the touch signal line is electrically connected to the first electrode through the first opening.
